(19) United States
(12) Patent Application Publication
(10) Pub. No.: US 2008/0066172 A1
(43) Pub. Date: Mar. 13, 2008

(54) Secured web syndication

(75) Inventor: Yuval Tarsi, Kfar Saba (IL)

Correspondence Address: NIXON & VANDERHYE, PC, 901 NORTH GLEBE ROAD, 11TH FLOOR, ARLINGTON, VA, 22203, US

(73) Assignee: WORKLIGHT LTD., Yakum (IL)

(21) Appl. No.: 11/896,740

(22) Filed: Sep. 5, 2007

(30) Foreign Application Priority Data
Sep. 5, 2006 (IL) 177904

(51) Int. Cl. G06F 15/16; H04L 9/32

(52) U.S. Cl. 726/9; 726/12

(57) ABSTRACT

A method and system for securely handling privileged content in web syndication applications operating within a computer network and utilizing a web aggregator operating over a data network linked to a computer network and one or more web servers capable of receiving web feed requests and providing corresponding web feeds, wherein at least some of said web feeds comprise an identifier referencing privileged content, said identifier is provided in response to web feed requests relating to said privileged content, and wherein a proxy server located within said computer network is utilized for handling web feeds requests and for replacing the identifiers in the web feeds with corresponding privileged content, whenever such identifiers are received in response to web feed requests issued by authorized users within the computer network.

### FIELD OF THE INVENTION

The present invention relates to web syndication. More particularly, the invention relates to a method and system for securely adding privileged content in web syndication implementations.

### BACKGROUND OF THE INVENTION

Web syndication is a form of content sharing wherein, for example, the content of a website is made available for other websites. Typically, websites which support web syndication comprise accessible text files, usually referred to as web feeds or channels that are associated with the shared content.

Web feeds comprise a list of content items referring to the shared content of a website. Typically, web feeds are XML documents which content items consist of a title, description, and a URL link to a webpage, as well as other relevant information such as the date in which the content was made available and the details of the author of the content. The description may comprise a summary of the new content, or the new content itself, and the URL link usually points to the new content.

A feed reader or aggregator application is a computer program used for subscribing to web feeds defined by a user for retrieving the syndicated web content, and to combine the retrieved contents of multiple web feeds for display. Feed aggregators can be used for checking a list of user defined feeds and for displaying update information whenever there is an update in any of the feeds defined by the user. Feed aggregators are provided as stand alone applications, or as built in services in web browsers (e.g., Firefox, Opera) and websites (e.g., Yahoo, Google). There are various web formats, such as RSS and Atom, which are supported by various feed aggregators used nowadays.

Websites comprising feed aggregators (e.g., My Yahoo!, My MSN) are also known as personalized homepage services, since they permit internet users to maintain a personalized homepage comprising user defined web feeds, where said personalized homepage can be accessed by a user whenever needed. Often, the personalized homepages are loaded first by default to the web browsers of internet users which subscribe to such personalized homepage services whenever they start their web browsers.

Personalized homepage services allow users to subscribe to web feeds obtained from various information sources and have the information retrieved from those sources displayed in their personalized homepage. Common web feeds topics include news headlines, stock quotes, local weather, technology, sports and many others topics. Topics can be selected from a list provided by the personalized homepage service or by providing a URL for a web resource that contains web feeds in the appropriate format.

Personalized homepage services may be advantageously used by companies to allow their employees to access the information most relevant for them and have a uniform user experience at home and at the workplace. However, the accessibility of corporate information (hereinafter also referred to as privileged content) is typically confined to the companies' internal corporate network (intranet), wherein employees can securely access information relevant to their work and day to day administrative information. In order to maintain security and prevent the access to corporate information, accessing this information through public channels is typically forbidden. Consequently, the utility of these internal networks is often limited due to the requirement that employees actively access the intranet to retrieve information from it. Some companies attempt to implement a policy in which the default page on the employees' web browsers is a corporate home page but this is difficult to enforce, especially in situations where employees use the same mobile computer both at home and at the workplace.

WO 2007/011917 describes a management system for network services which suggests employing a conditional access method with a plurality of network services. This international application suggests a conditional access method that may allow a user to post data via a post method to a service located at a URL, wherein the service verifies permission of the user to access content, and wherein a get method allows the user to get an indicator of permission to access the content.

In the syndicated transactions system described in WO 2001/086543 encrypted personal information is maintained in a store and may be accessed by verified or registered users by means of a personal information engine. In this system any attempt to access the personal information by verified or registered users is handled by a personal information access/transact component of the personal information engine which retrieve and decrypts the needed personal information from the store.

Various tools for an enhanced syndication are described in US 2006/0173985 which suggests employing encryption of items from RSS sources. The encrypted items are transmitted to a recipient who uses a decryption key associated with the particular source to authenticate or decrypt the communication. A system comprising a security layer for securely transmitting RSS or other feeds is further proposed for ensuring that only authorized subscribers can decode the feed. This publication further suggests using browsers to display both secure and insecure feeds within a single interface.

Heretofore, web syndication implementations mainly relied on cryptographic schemes for allowing secure access of privileged content by means of web based feed aggregators.

It is therefore an object of the present invention to provide a method and system for securely sharing privileged content in web syndication implementations.

It is another object of the present invention to provide a method and system for allowing privileged content to be securely accessed by authorized users using feed aggregators such as personalized homepage services.

It is a further object of the invention to provide a dedicated proxy server designed to allow authorized users to securely access privileged content by means of feed aggregators.

It is yet another object of the invention to allow companies to control and securely augment the content accessible by their employees via personalized home pages.

An additional object of the present invention is to provide a system, method and a modified web feed, which allows authorized users to securely access privileged content by means of conventional web aggregators.

Other objects and advantages of the invention will become apparent as the description proceeds.

### SUMMARY OF THE INVENTION

The present invention aims to provide a method and system for allowing users to securely access privileged content by conventional web based feed aggregators. In general, the system of the invention allows authenticated users to access privileged content by means of modified web feeds (also referred to herein as stub feeds), said modified web feeds comprise one or more identifiers referencing said privileged content.

The term privileged content is used herein to refer to classified information which may be accessed by authorized individuals only. The privileged content may comprise, but is not limited to, private, sensitive, confidential, and/or proprietary information.

The term secured network refers to a data network comprising security infrastructures (e.g., firewall) capable of preventing access of unauthorized users to the network resources. The security infrastructures preferably comprise means (e.g., Single sign on and authentication systems such as, but not limited to, Kerberos, and user directories such as, but not limited to, Active Directory) for authenticating users operating within the network and users attempting to access said network from external networks.

The term stub feed used herein refers to specially formatted web feeds that reference privileged content but which do not comprise such privileged content themselves, and as such may be publicly accessible without compromising security. The term stub server used herein refers to a web server configured to handle stub feeds, and optionally also regular web feeds, to which users can subscribe via conventional publicly accessible web syndication infrastructures.

The invention provides a method and system for securely handling privileged content in web syndication applications comprising a proxy server operating within a computer network, preferably a secured computer network, said proxy server is capable of handling web feeds requests (e.g., users' personalized homepages) issued within the computer network, and one or more web servers used for providing web feeds in response to web feed requests, wherein some of said web feeds may be modified web feeds provided in response to web feed requests relating to privileged content.

The web feed requests may be handled by one or more web aggregators adapted to periodically (or repeatedly) query the one or more web servers for updates regarding the web feeds to which users have subscribed, such that whenever web feed requests are received by said proxy server, it forwards said web feed requests to the one or more web aggregators which in turn forwards the requested web feeds, some of which may include modified web feeds (stub feeds), to the proxy server, wherein the dedicated proxy server receives and processes the web feeds, and whenever a modified web feed is received in response to a web feed request issued from the computer network the proxy server replaces the one or more identifiers with the relevant privileged content.

Alternatively, the privileged content may be retrieved by a client application of the user by replacing the one or more identifiers provided in the web feeds with a corresponding retrieval script to be executed by said client application.

In one aspect the present invention relates to a method for securely handling privileged content in web syndication applications operating within a computer network, preferably a secured computer network, the method comprising: sending web feeds requests to a proxy server operating within said computer network, wherein some, or all, of said web feed requests are optionally associated with privileged content; sending (e.g., over the Internet) said web feeds requests to a web aggregator configured for periodically, or repeatedly, retrieving web feeds associated with said web feed requests, wherein some, or non, of said web feeds comprises identifiers referencing privileged content received in response to web feed requests associated with privileged content; sending said web feeds to said proxy server, and upon receipt, whenever identifiers referencing privileged content are contained in said web feeds, verifying that said web feed requests were issued from within said computer network, replacing said identifiers referencing privileged content with the relevant privileged content and forwarding the web feeds to a client application (e.g., web browser) of a user communicating via said computer network, said user is preferably a authenticated user (e.g., by means of a user name and password).

The web aggregator may optionally be a personalized web service. The proxy server is preferably a conventional proxy server which was modified for handling requests for personalized homepages issued within the computer network, processing said personalized homepages, and replacing the identifiers received therewith the referenced privileged content.

Dedicated web server(s) may be employed for handling the web feeds requests associated with privileged content, wherein said dedicated web servers are adapted to provide modified web feeds in response to such requests, and optionally a token for identifying the user requesting to access the privileged content.

Optionally, the privileged content may be received by means of a retrieval script placed by the proxy server in the web feeds containing identifiers referencing privileged content instead of said privileged content, said retrieval script is executed by the client application of the user.

In another aspect the present invention relates to a system for securely managing privileged content in web syndication application, comprising: one or more web aggregators operating over a data network (e.g., the Internet); a computer network, preferably a secured computer network, connected to said data network; one or more web servers capable of communicating with the data network and capable of receiving web feed requests and providing corresponding web feeds, wherein at least some of said web feeds comprise an identifier referencing privileged content, said identifier is provided in response to web feed requests relating to said privileged content; a proxy server configured to communicate from said computer network and adapted to handle web feeds requests issued within said computer network.

Preferably, the proxy server is capable of verifying that the web feed requests are issued from within the computer network. Optionally, the proxy server is also capable of authenticating the users.

Conveniently, the one or more web aggregators are a personalized web service.

Preferably, at least one of the web servers is a dedicated web server adapted to handle web feeds requests relating to privileged content, said dedicated web server is preferably configured to provide web feeds comprising identifiers referencing privileged content and optionally a token for identifying a user in the computer network.

The proxy server is capable of replacing the identifiers with the relevant privileged content, or with a respective retrieval script for securely retrieving said privileged content from within said secured network, upon successful verification and/or authentication of the users.

In yet another aspect the present invention relates to a secured web syndication capable of providing access to privileged content by means of modified web feeds, said modified web feeds are provided by wed server(s) in response to web feed requests relating to such privileged content and comprise one or more identifiers referencing the requested privileged content, and a proxy server capable of handling web feed requests of users in a computer network, preferably a secured computer network, and replacing said identifiers with said requested privileged content, or with a corresponding script for retrieving the same, whenever such modified web feed is received.

Preferably, the access to the privileged content is granted to authenticated users only.

Conveniently, the web feeds are provided by a personalized homepage service.

### BRIEF DESCRIPTION OF THE DRAWINGS

The present invention is illustrated by way of example in the accompanying drawings, in which similar references consistently indicate similar elements and in which:

FIG. 1 schematically illustrates a preferred embodiment of a system allowing to securely share privileged content by means of conventional feed aggregators;

FIG. 2 demonstrates a XML web feed suitable for use in a possible implementation of the invention;

FIG. 3 is a flowchart illustrating a general process of the invention for handling a request for a personalized homepage which may comprise feeds relating to privileged content; and

FIG. 4 is a flowchart illustrating a process for securely adding web feeds relating to privileged content in a possible implementation of the invention.

### DETAILED DESCRIPTION OF PREFERRED EMBODIMENTS

The present invention aims to provide a method and system for allowing users to securely access privileged content by conventional publicly accessible feed aggregators. In general, the system of the invention uses dedicated servers which are adapted for implementing a modified web syndication scheme that allows authenticated users to access privileged content provided by means of modified web feeds (stub feeds).

In a preferred embodiment of the invention a dedicated proxy server is used for handling requests for personalized homepage services issued by authenticated users, and for permitting access to privileged content referenced by web feeds (stub feeds), said proxy server also being sometimes referred to herein as a personalized homepage augmentation proxy (PHAP). The PHAP is a sub-system in the web syndication system of the invention that allows end-users to use their web-based feed aggregators (e.g., RSS web aggregators) to securely access privileged content by means of stub feeds. In general, but not necessarily, the access to the privileged content is granted to authorized users only when said users attempt to access it from a secured network (e.g., employees workstations connected via an enterprise network), or via a secure connection thereto, such as, but not limited to, VPN (virtual private network). When attempting to access said privileged web feeds from an external network, the access will be blocked and the user may optionally be informed that such access is forbidden.

The PHAP of the invention may be used by companies to securely provide access to corporate information to employees via the employees' personalized homepages. This makes it possible for the company to make relevant information available to its employees without requiring the employees to actively access the corporate intranet and without implementing difficult-to-enforce IT (information technology) policies.

Secure access is achieved by means of the PHAP of the invention by having the employees subscribe to stub feeds. The stub server provides the personalized homepage service stub feeds which include identifiers (hereinafter also referred to as stub identifiers) relating to the requested privileged content, rather than the privileged content itself, such that when the employee accesses the personalized homepage from within the corporate network, the PHAP authenticates the user, processes said identifiers and securely replaces the stub feeds with the relevant privileged content (e.g., corporate information). When the employee accesses the personalized homepage from outside the corporate network, the access to the privileged content is denied, and optionally, an informative message is displayed to the user stating that such access to the corporate information is forbidden.

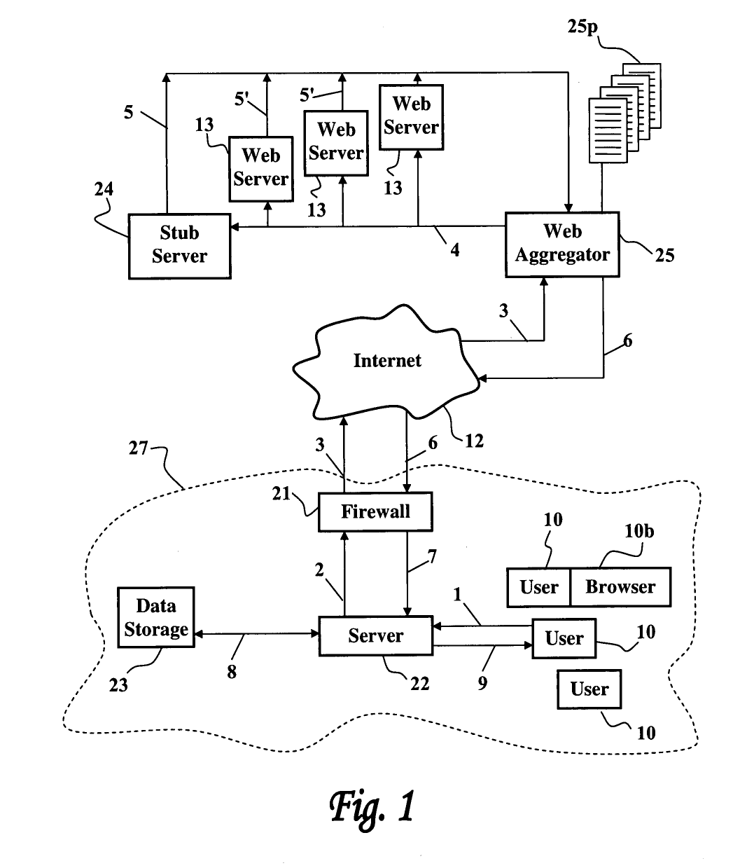

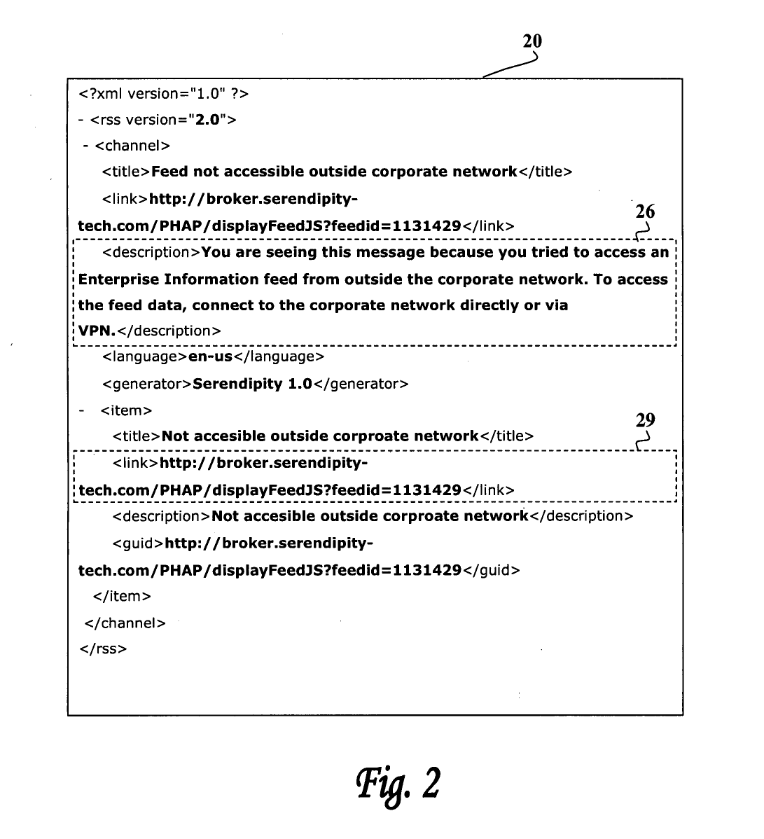

FIG. 1 schematically illustrates a preferred embodiment of a system allowing securely sharing privileged content using web-based feed aggregators within a secured network 27 (e.g., corporate network) [symbol] In this preferred embodiment the PHAP comprises a stub Server 24 and a proxy server 22 connected by means of a data network infrastructure (e.g., the internet 12). The Stub Server 24 is situated outside the secured network 27 and it serves stub feed requests originating from web aggregator 25 (personalized homepage service e.g., My Yahoo!, My MSN). The users' personalized homepages 25p handled by web aggregator 25 may comprise regular user defined web feeds and stub feeds that users 10 (e.g., employees) have subscribed to via a computer terminal (or other computerized means) connected via network 27. The stub feeds are preferably structured in the form of a regular web feed (e.g., RSS feed, as exemplified in FIG. 2) but which further include information identifying the requested privileged content.

In response to stub feed requests the stub server 24 responds with a corresponding stub feed comprising data identifying the requested content (stub identifier, 29 in FIG. 2), a default message (26 in FIG. 2) to be displayed whenever the user 10 attempts to access stub feeds from outside network 27, and optionally a token used by proxy server 22 to identify the user.

Proxy server 22 is situated within the secured network 27 and all its communications are carried out therethrough. The secured network access infrastructure (e.g., Firewall, organizational proxy/cache etc.) should be configured accordingly so that requests for personalized homepage services are served by the secured network proxy server 22. When proxy server 22 detects a stub feed, it requests authentication of the user from an authentication system (e.g., Kerberos, not shown), and once the user is authenticated, the proxy server 22 can provide the user access to the privileged content identified by the stub feed.

In a typical scenario a request (1) for a personalized homepage service issued by user 10 is received by the proxy server 22 which handles the request on behalf of user 10. Next, the proxy server 22 forwards the request (2) to the web aggregator 25, which may involve passage (3) via firewall, and/or other network security means, 21. During its regular operation the aggregator 25 (e.g., personalized homepage service) sends requests for web and/or stub feeds (4) and retrieves web feeds (5′) from web servers 13 and stub feeds (5) from stub server 24. Aggregator 25 sends the requested personalized homepage (6 and 7), comprising the web feeds and the stub feeds to which the user had subscribed, to proxy server 22, whenever a request for the personalized homepage is received from said proxy server.

The proxy server 22 receives the personalized homepage (7) processes the stub identifiers contained in the stub feeds, and verifies the user's identity, and that the user request was initiated from within the secured network 27 i.e., user authentication. The user authentication is preferably carried out by the network's built-in authentication infrastructures. Of course, the network's authentication system may apply rules based on the way users access the network (e.g. from a corporate LAN, or using VPN from home over a DSL connection or from a wireless network etc.), most often based on the user's IP address, and decide not to authorize the user according to some predetermined permission policy. If the identity of user 10 is verified and it is determined that the request was initiated from within the secured network 27 the proxy server 22 retrieves the corresponding privileged content from an information system-data storage 23 e.g., enterprise information system, preferably over an API (application programming interface). The proxy server 22 then replaces the stub identifiers contained in the stub feeds with the relevant privileged content information retrieved and sends the requested information to user 10. The personalized homepage comprising, the web feed and the privileged content referenced by the stub feed is received by the computer terminal (or other computerized means) of user 10, and it then may be displayed by suitable client application, such as browser 10b.

Proxy server 22 is a modified proxy server adapted to handle the web syndication scheme of the invention. Proxy server 22 may be implemented using a HTTP proxy server which may be implemented by extending an existing HTTP proxy server using mechanisms such as Apache filters or ISAPI filters.

Stub server 24 may be implemented using any standard HTTP server capable of responding to appropriately formatted HTTP requests by returning a stub feed in the form of a respectively formatted XML document.

FIG. 2 demonstrates a possible XML web feed suitable for use as a stub feed 20 in a possible implementation of the invention. As discussed hereinabove, stub feed 20 comprises a stub identifier 29 used for referencing the content (e.g., feedid=1131429) to be provided to user 10.

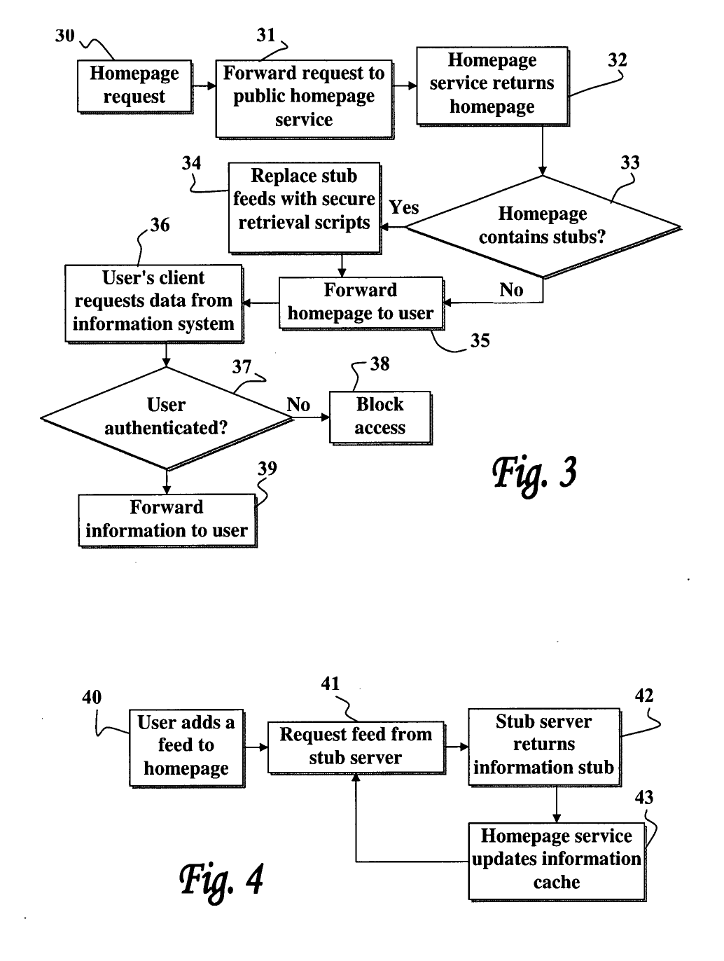

FIG. 3 is a flowchart illustrating a general process of the invention for handling a request for a personalized homepage which may contain stub feeds (e.g., 20 in FIG. 2). In this process the privileged content is retrieved directly by the user as will be described hereinafter. The process is initiated in step 30 when user 10 requests to download a personalized homepage. Next, in step 31 proxy server 22 processes the user's request and forwards it to the web aggregator 25. As was described herein before, during its regular operation the web aggregator 25 retrieves the requested web feeds (5′ in FIG. 1) from the relevant websites 13 and the corresponding stub feeds (5 in FIG. 1) from the stub server 24. Whenever a request for a personalized home page is requested, in step 32, the web aggregator 25 returns the personalized homepage, containing the requested web feed and any optionally requested stub feeds, to the proxy server 22.

In step 33 the personalized homepage is received and processed by proxy server 22, and in step 34 stub identifiers contained in the stub feeds (if any) in the personalized homepage are replaced by the proxy server 22 with corresponding retrieval scripts. More particularly, the proxy server 22 replaces the feed identifiers with HTML tags that cause the user's web browser to retrieve and execute client-side code that renders the appropriate content in the user's browser. Next, in step 35, the personalized homepage is forwarded to user 10 and in step 36 the user's client application (e.g., internet browser) executes the retrieval scripts and issues corresponding requests for the privileged content which are forwarded to the information system (data storage 23).

After receiving the requests for privileged content from the user, in step 37, the information system 23 verifies that the user is an authorized user operating from within the secured network 27, and if so, in step 39, forwards the requested privileged content to user 10.

The user may be authenticated using existing authentication infrastructure e.g. an existing active directory server or similar system. Thus, the authentication policy is typically determined by an external system, and if the user is successfully authenticated, the privileged content is made accessible.

If it is determined that the user is not an authorized user or that said user is attempting to access the privileged content from outside of secured network 27, the access attempt is blocked in step 38.

FIG. 4 is a flowchart illustrating a process for adding stub feeds to a personalized homepage in a possible implementation of the invention. After user 10 subscribes to a new stub feed in step 40, in step 41, the web aggregator 25 forwards a request to the stub server 24 requesting the new stub feed. Thereafter, in step 42, stub server 24 returns a corresponding stub feed (20) containing the relevant identifiers (29), as was previously discussed hereinabove. After receiving the stub feed the web aggregator 25 updates its information cache and routinely checks for updates by repeating steps 41 to 43 periodically.

As described hereinabove the present invention provides web syndication implementations allowing secure access to privileged content by means of web based feed aggregators, which does not employ any cryptographic schemes. Moreover, the method and system of the invention allows securely sharing privileged content in web syndication implementations by means of conventional publicly accessible web aggregators and conventional client applications. The secure syndication of the invention advantageously allows the users to subscribe to regular web feeds and to stub feeds, and to view both privileged and non-privileged content in their personalized homepages.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for securely handling privileged content in web syndication applications operating within a computer network, comprising:
sending web feed requests to a proxy server operating within said computer network, wherein some, or all, of said web feed requests are optionally associated with privileged content;
sending said web feed requests to a web aggregator configured for periodically, or repeatedly, retrieving web feeds associated with said web feed requests, wherein some, or non, of said web feeds comprises identifiers referencing privileged content received in response to web feed requests associated with privileged content;
sending said web feeds to said proxy server, and upon receipt, whenever identifiers referencing privileged content are contained in said web feeds, verifying that said web feed requests were issued from within said computer network, and replacing said identifiers referencing privileged content with the relevant privileged content.

2. The method according to claim 1, wherein the web aggregator is a personalized web service.

3. The method according to claim 2, wherein the proxy server is capable of handling requests for personalized homepages issued within the computer network, processing said personalized homepages, and replacing the identifiers received therewith the referenced privileged content.

4. The method according to claim 1, wherein the web feeds received in response to web feed requests associated with privileged content are received from a dedicated web server adapted to handle such web feeds requests.

5. The method according to claim 4, wherein the dedicated web server is configured to provide web feeds comprising identifiers referencing privileged content and optionally a token for identifying a user in the computer network.

6. The method according to claim 1, wherein the computer network is a secured computer network.

7. The method according to claim 1, wherein the web feed requests and the web feeds are communicated via the internet.

8. The method according to claim 1, further comprising authenticating the user whenever identifiers referencing privileged content are contained in the web feeds.

9. A method according to claim 1, further comprising sending the received web feeds to a client application of the user.

10. A method according to claim 9, wherein the privileged content is received by means of a respective retrieval script placed by the proxy server in the web feeds containing identifiers referencing privileged content instead of said privileged content, said retrieval script is executed by the client application.

11. A system for securely managing privileged content in web syndication application, comprising:
one or more web aggregators operating over a data network;
a computer network connected to said data network;
one or more web servers connected to said data network and capable of receiving web feed requests and providing corresponding web feeds, wherein at least some of said web feeds comprise an identifier referencing privileged content, said identifier is provided in response to web feed requests relating to said privileged content;
a proxy server located within said computer network and adapted to handle web feeds requests issued within said computer network.

12. A system according to claim 11, wherein the proxy server is capable of verifying that the web feed requests were issued from within the computer network.

13. A system according to claim 11, wherein the proxy server is capable of authenticating the users.

14. A system according to claim 11, wherein the one or more web aggregators is a personalized web service.

15. A system according to claim 11, wherein at least one of the web servers is a dedicated web server adapted to handle web feeds requests relating to privileged content.

16. A system according to claim 15, wherein the dedicated web server is configured to provide web feeds comprising identifiers referencing privileged content and optionally a token for identifying a user in the computer network.

17. A system according to claim 11, wherein the computer network is a secured computer network.

18. A system according to claim 11, wherein the data network is the Internet.

19. A system according to claim 11, wherein the proxy server is capable of replacing the identifiers with the relevant privileged content, or with a respective retrieval script for securely retrieving said privileged content from within said secured network, upon successful verification and/or authentication of the users.

20. A secured web syndication capable of providing access to privileged content by means of modified web feeds, said modified web feeds are provided by wed server(s) in response to web feed requests relating to such privileged content and comprise one or more identifiers referencing the requested privileged content, and a proxy server capable of handling web feed requests of users in a computer network and replacing said identifiers with said requested privileged content, or with a corresponding script for retrieving the same, whenever such modified web feed is received.

21. The secured syndication according to claim 20, wherein the computer network is a secured computer network.

22. The secured syndication according to claim 20, wherein the access to the privileged content is granted to authenticated users only.

23. The secured syndication according to claim 20, wherein the web feeds are provided by a personalized homepage service.
